(19) United States
(12) Patent Application Publication
(10) Pub. No.: US 2024/0195012 A1
(43) Pub. Date: Jun. 13, 2024

(54) SEPARATOR, METHOD OF MANUFACTURING THE SEPARATOR, AND ELECTROCHEMICAL DEVICE INCLUDING THE SEPARATOR

(71) Applicants: SK INNOVATION CO., LTD., Seoul (KR); SK IE TECHNOLOGY CO., LTD., Seoul (KR)

(72) Inventors: Tae Wook KWON, Daejeon (KR); Heung Taek BAE, Daejeon (KR)

(21) Appl. No.: 18/523,585

(22) Filed: Nov. 29, 2023

(30) Foreign Application Priority Data
Nov. 30, 2022 (KR) 10-2022-0164876

(51) Int. Cl. H01M 50/451; H01M 50/403; H01M 50/42; H01M 50/423; H01M 50/431; H01M 50/443; H01M 50/446; H01M 50/457; H01M 50/489

(52) U.S. Cl. CPC H01M 50/451; H01M 50/403; H01M 50/42; H01M 50/423; H01M 50/431; H01M 50/443; H01M 50/446; H01M 50/457; H01M 50/489

(57) ABSTRACT

Provided are a separator, a method of manufacturing the separator, and an electrochemical device including the separator. According to an embodiment, a separator including: a porous substrate; and an inorganic particle layer including a binder and inorganic particles on at least one surface of the porous substrate may be provided, wherein the binder is a water-soluble binder including a (meth)acrylamide-based monomer polymerization unit and the separator has a value of the following Formula (1) satisfying 0.15 or more:

BDV/t (1)
wherein
‘BDV’ is a voltage (kV) measured in accordance with ASTM D 3755, when a leakage current value is 5 mA, measured under conditions of raising an applied voltage at 5 kV/10 sec after placing the separator between electrodes of a withstand voltage tester (Hipot Tester), and
‘t’ is an overall average thickness (μm) of the separator.

### CROSS-REFERENCE TO RELATED APPLICATIONS

This patent document claims priority under 35 U.S.C. § 119 to Korean Patent Application No. 10-2022-0164876, filed on Nov. 30, 2022, the disclosure of which is incorporated herein by reference in its entirety.

### TECHNICAL FIELD

This patent document relates to a separator in an electrochemical device such as a secondary battery, a method of manufacturing the separator, and an electrochemical device including the separator.

### BACKGROUND

Recently, as the demand for eco-friendly energy increases, research on electrochemical devices is in progress in various fields such as electrical vehicles, including electronic devices such as mobile phones and PC. An insulating separator interposed between a positive electrode and a negative electrode is being studied for thinning for the high capacity/high output characteristics of an electrochemical device, but due to the thinning trend of the separator, a low-voltage defective rate of a battery is increased. Even when a low-voltage defect occurs in only one battery of a battery pack of an electric vehicle, which includes dozens of batteries, many normal batteries should be discarded, and thus, it is a very important industrial challenge to lower the low-voltage defective rate of a battery.

The low-voltage defect of a battery refers to a phenomenon showing a voltage drop behavior at or above a normal self-discharge rate, and is presumed to be caused complexly by various causes such as foreign substances in a separator, defects such as pinholes, and in the case of a ceramic coating separator, a composition and a distribution of an inorganic layer, and withstand voltage properties of the separator itself.

Therefore, development of a new separator which may suppress the low-voltage defective rate of a battery as described above while having a small thickness is needed. In addition, development of a new separator which satisfies all of heat resistance, adhesion to an electrode, and the like, which are key characteristics required for a conventional separator, while suppressing the low-voltage defective rate of a battery is needed.

### SUMMARY

An embodiment of the present disclosure is directed to providing a separator which may significantly decrease a low-voltage defective rate of a battery even with a small thickness, a method of manufacturing the separator, and an electrochemical device including the separator.

Another embodiment of the present disclosure is directed to providing a separator which significantly decreases the low-voltage defective rate of a battery and also has excellent heat resistance and adhesion.

In one general aspect, a separator includes: a porous substrate; and an inorganic particle layer including a binder and inorganic particles on at least one surface of the porous substrate, wherein the binder is a water-soluble binder including a (meth)acrylamide-based monomer polymerization unit, and the separator has a value of the following Formula (1) satisfying 0.15 or more:

BDV/t (1)

Wherein ‘BDV’ is a voltage (kV) measured in accordance with ASTM D 3755, when a leakage current value is 5 mA, measured under conditions of raising an applied voltage at 5 kV/10 sec after placing the separator between electrodes of a withstand voltage tester (Hipot Tester), and ‘t’ is an overall average thickness (μm) of the separator.

According to an embodiment, in a particle size distribution of inorganic particles, a (D80−D20)/D50 value may be 0.01 to 2.0.

According to an embodiment, when an average thickness of the porous substrate is t₁, a t₁/t value may be 0.65 or more.

In an embodiment, the inorganic particle layer may have a packing density of 1.45 g/(m²·μm) or more.

In an embodiment, the porous substrate may include a polar functional group on the surface.

In an embodiment, a heat shrinkage rate in the machine direction (MD) and the transverse direction (TD) may be 2% or less, which was measured after the separator is allowed to stand at 150° C. for 60 minutes.

In an embodiment, the binder may be a copolymer including the (a) (meth)acrylamide-based monomer polymerization unit, a (b) hydroxyl group-containing (meth)acrylate-based monomer polymerization unit, and a (c) polyfunctional (meth)acrylamide-based monomer polymerization unit.

In an embodiment, the (c) polyfunctional (meth)acrylamide-based monomer polymerization unit in the copolymer may include a structure of the following Chemical Formula 3:

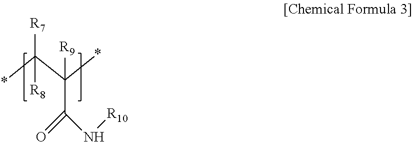

wherein R₇ to R₉ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group, and R₁₀ is a C1 to C10 linear or branched hydrocarbon group including one or more of a hydroxyl group, a carboxyl group, an amine group, an amide group, an ether group, a ketone group, an ester group, and an aldehyde group.

In an embodiment, the copolymer may include a structure of the following Chemical Formula 4:

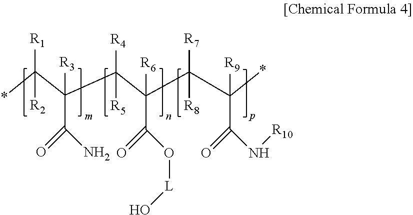

wherein R₁ to R₉ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group, R₁₀ is a C1 to C10 linear or branched hydrocarbon group including one or more of a hydroxyl group, a carboxyl group, an amine group, an amide group, an ether group, a ketone group, an ester group, and an aldehyde group, L is a C1 to C6 substituted or unsubstituted, linear or branched alkylene group, m is 65 to 96, n is 4 to 34, and p is 0.001 to 1.

In an embodiment, in Chemical Formula 4, p may be 0.01 to 1.

In an embodiment, the binder may have a weight average molecular weight of 100,000 to 2,000,000 g/mol.

In an embodiment, the inorganic particle layer may have a thickness of 3 μm or less.

In another general aspect, a method of manufacturing a separator includes: (s1) preparing a slurry including a water-soluble binder including a (meth)acrylamide-based monomer polymerization unit and inorganic particles; and (s2) forming an inorganic particle layer on at least one surface of a hydrophilically surface-treated porous substrate with the prepared slurry.

According to an embodiment, in the inorganic particle layer, a (D80−D20)/D50 value may be 0.01 to 2.0.

In an embodiment, the water-soluble binder may be a copolymer of the (a) (meth)acrylamide-based monomer, a (b) hydroxyl group-containing (meth)acrylate-based monomer, and a (c) polyfunctional (meth)acrylamide-based monomer.

In an embodiment, the process (s2) may further include applying the prepared slurry on at least one surface of the hydrophilically surface-treated porous substrate, and then allowing it to stand for 5 minutes or more.

In an embodiment, the hydrophilic surface treatment of the porous substrate may be performed by including one or more of a corona discharge treatment and a plasma discharge treatment.

In still another general aspect, an electrochemical device includes the separator according to the embodiment described above.

The above aspects and other aspects or features and aspects of the disclosed technology are described in more detail in the following detailed description, the drawing and the claims.

### BRIEF DESCRIPTION OF DRAWING

FIG. 1 shows an example of a separator disclosed in this patent document.

FIG. 2 shows an example of a separator disclosed in this patent document.

### DETAILED DESCRIPTION OF EMBODIMENTS

Hereinafter, the present disclosure will be described in more detail by the following embodiment or the examples. However, the following embodiments or examples are only a reference for describing the present disclosure in detail, and the present disclosure is not limited thereto and may be implemented in various forms.

In addition, unless otherwise defined, all technical terms and scientific terms have the same meanings as those commonly understood by one of those skilled in the art to which the present disclosure pertains. The terms used herein are only for effectively describing a certain specific example, and are not intended to limit the present disclosure.

In addition, unless particularly described to the contrary, “comprising” any elements will be understood to imply further inclusion of other elements rather than the exclusion of any other elements.

In the present specification, “(meth)acryl” refers to acryl and/or methacryl.

In the present specification, “substituted” in the expression “substituted or unsubstituted” means that one or more hydrogen atoms in a hydrocarbon are independently of each other replaced with the same or different substituent. A non-limiting example of the substituent may include deuterium, a halogen group, a hydroxyl group, an amino group, a C1 to C30 amine group, a nitro group, a C1 to C30 silyl group, a C1 to C30 alkyl group, a C1 to C30 alkylsilyl group, a C3 to C30 cycloalkyl group, a C1 to C30 heterocycloalkyl group, a C6 to C30 aryl group, a C1 to C30 heteroaryl group, a C1 to C20 alkoxy group, a C1 to C10 trifluoroalkyl group or a cyano group.

“Dn” (n is a real number) in the present specification refers to a particle diameter of particles which is equivalent to n % in terms of a volume-based integrated fraction. That is, “Dn” is a particle diameter in a material in which all particles in that material have a particle size distribution with n % of the particles with diameters below this diameter Dn. For example, “D80” refers to a particle diameter of particles which is equivalent to 80% in terms of a volume-based integrated fraction so that 80% of the particles have particle diameters less than D80. “D20” refers to a particle diameter of inorganic particles which is equivalent to 20% in terms of a volume-based integrated fraction so that 20% of the particles have particle diameters less than D20. Dn may be derived from particle size distribution results obtained by collecting a sample of inorganic particles to be measured via a laser diffraction method in accordance with the standard of KS A ISO 13320-1¹ and performing analysis using Multisizer 4e Coulter counter available from Beckman Coulter. The D50, D80, and D20 specifications in the present disclosure refers to the inorganic particles which have been used to be added to, and included into, the preparation for obtaining the inorganic particle layer. ¹ See ISO website at https://www.iso.org/standard/69111.html.

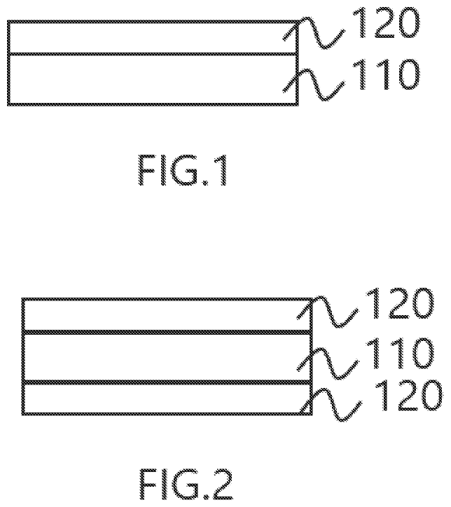

In the present specification, an “overall average thickness (t) of a separator” refers to an overall average thickness of a separator. FIG. 1 shows one example of a separator based on the disclosed technology which includes a porous substrate 110 and an inorganic particle layer 120 provided on at least one surface of the porous substrate 110. FIG. 2 shows one example of a separator based on the disclosed technology which includes a porous substrate 110 and an inorganic particle layer 120 provided on both surface of the porous substrate 110. FIGS. 1 and 2 are illustrative of an aspect, and the present disclosure is not limited to FIGS. 1 and 2. In addition, the separator according to one aspect of the present disclosure may further comprise other layers. In an embodiment, the overall average thickness (t, μm) of the separator may be determined by the following method. The separators are overlapped in 10 layers, each thickness is measured at 5 random points in TD by a thickness meter available from Mitutoyo, the values are divided by 5 to derive an average thickness of the 10-layer separator, and are divided by 10 again to derive an overall average thickness of a single separator.

In the present specification, an “average thickness (t₁) of a porous substrate” refers to an average thickness of only a porous substrate having no inorganic particle layer provided on at least one surface. In an embodiment, an average thickness t₁ in microns (μm) of the porous substrate may be determined by the following method. Only porous substrates having no inorganic particle layer provided on at least one surface are overlapped in 10 layers, then the thickness of the 10-layer porous substrate (without a inorganic particle layer on at least one surface thereof) is measured at each of 5 random points in TD with a thickness meter available from Mitutoyo, the values are divided by 5 to derive an average thickness of the 10-layer porous substrate, and are divided by 10 again to derive the average thickness t₁ of the porous substrate. In the case in which the average thickness t₁ of the porous substrate having the inorganic particle layer provided on at least one surface is determined, the inorganic particle layer is released using a suitable releasing method such as methods known in the art without limitation and is sufficiently dried, and the average thickness t₁ of the porous substrate from which the inorganic particle layer has been released is determined.

In the present specification, a “packing density of inorganic particle layer” refers to a density (g/(m²·μm)) of the inorganic particle layer loaded to a unit area (m²) and a unit height in microns (μm) of the porous substrate. In an embodiment, a method of measuring the packing density of the inorganic particle layer may be according to the following method. The average thickness t₁ of the porous substrate and the overall average thickness t of the separator having the inorganic particle layer provided on the porous substrate are measured according to the method described above, respectively, and the average thickness t₁ of the porous substrate is subtracted from the overall average thickness t of the separator to calculate the thickness (T, μm) of the inorganic particle layer. The separator having the inorganic particle layer provided on at least one surface of the porous substrate is cut into an area (S, m²) of 10 mm×10 mm (0.01 m²) to measure the weight, and the weight of the porous substrate is subtracted therefrom to calculate the weight (W, g) of only the inorganic particle layer. The packing density of the inorganic particle layer is calculated by W/(T*S).

The present disclosure has been devised based on the idea that when the water-soluble binder of the present embodiment is included as the binder of the inorganic particle layer of the separator and the value of the following Formula (1) is controlled to a specific range, a low-voltage defective rate in which voltage is decreased at the voltage of a battery to be desired may be significantly decreased even with a small thickness and also excellent thermal resistance and adhesion may be secured.

According to an embodiment, a separator which includes a porous substrate; and an inorganic particle layer including a binder and inorganic particles on at least one surface of the porous substrate may be provided, wherein the binder is a water-soluble binder including a unit derived from (meth)acrylamide-based monomer, and when a value of the following Formula (1) is controlled to a specific range, a low-voltage defective rate of a battery may be significantly decreased even with a small thickness and also heat resistance and adhesion are excellent:

BDV/t (1)

wherein ‘BDV’ is a voltage in kilovoltage (kV) measured in accordance with ASTM D 3755 when a leakage current value is 5 mA, which is measured under conditions of placing the separator between electrodes of a withstand voltage tester (e.g. the tester available from Croma, model 19052) under a dry room (dew point temperature: −60° C.) and then an applied voltage is raised at 5 kV/10 sec. The voltage herein is evaluated as a dielectric breakdown voltage. ‘t’ is an overall average thickness in microns (μm) of the separator. The withstand voltage tester may apply test voltages to measure a breaking current of the separator.

In an embodiment, the value of Formula (1) may be 0.15 or more or 0.153 or more, or 0.155 or more, and though the upper limit of the value of Formula (1) is not particularly limited, for example, may be 0.3 or less, 0.25 or less, or 0.2 or less. In an embodiment,, the value of Formula (1) may be 0.15 to 0.3, 0.153 to 0.25, or 0.155 to 0.2, but is not limited thereto.

The separator according to an embodiment may significantly decrease a low-voltage defective rate of a battery and also may secure excellent heat resistance and high capacity/high output characteristics at a high temperature, even when a thin inorganic particle layer is provided on at least one surface, and, in some implementations, an inorganic particle layer may be formed on both surfaces of the porous substrate. In an embodiment, when an average thickness of the porous substrate is t₁, a t₁/t value may be 0.65 or more, 0.67 or more, 0.69 or more and less than 1.0, 0.9 or less, 0.8 or less, or a value between the numerical values. In an embodiment, the t₁/t value may be 0.65 or more, 0.65 or more and less than 1.0. In an embodiment, the t₁/t value may be 0.67 or more, or 0.67 or more and 0.9 or less.

In an embodiment, when a hydrophilic surface treatment including one or more of a corona discharge treatment and a plasma discharge treatment is performed on the porous substrate, the packing density of the inorganic particle layer may be further increased, thereby further decreasing the low-voltage defective rate of a battery with a thin separator, but the present disclosure is not limited thereto. In the embodiment, a polar functional group is provided on the surface of the porous substrate by the corona discharge treatment or the plasma discharge treatment, and the provided polar functional group is bound to the water-soluble binder which fixes the inorganic particle layer chemically or closely by a secondary binding force such as a hydrogen bond, thereby further decreasing the low-voltage defective rate of a battery.

Hereinafter, each constituent of the separator according to embodiments of the present disclosure will be described.

According to an embodiment, the porous substrate may use polyolefin such as polyethylene and polypropylene, and the like, and may be a film or sheet formed of any one or two or more resins selected from the group consisting of the polyolefins.

The polyolefin-based porous substrate is usually manufactured in a film form and is not limited as long as it is usually used as a separator of an electrochemical device, and an example thereof includes polyethylene, polypropylene, copolymers thereof, and the like, but is not necessarily limited thereto.

The thickness of the porous substrate is not particularly limited, but for example, may be 1 μm or more, 3 μm or more, 5 μm or more and 100 μm or less, 50 μm or less, 30 μm or less, 20 μm or less, 15 μm or less, 10 μm or less, or a value between the numerical values. The thickness of the porous substrate may be, as a non-limiting example, 1 to 100 μm, for example, 5 to 50 μm, and more for example 5 to 30 μm. The porous substrate may be, according to an example, a porous polymer substrate manufactured by stretching.

In an embodiment, the porous substrate may include a polar functional group on the surface. A non-limiting example of the polar functional group may include a carboxyl group, an aldehyde group, a hydroxyl group, and the like, but is not particularly limited. The polar functional group may be, according to an example, introduced by a hydrophilic surface treatment, and the hydrophilic surface treatment may be performed by including, according to an example, one or more of a corona discharge treatment and a plasma discharge treatment. The polar functional group provided on the surface of the porous substrate and a water-soluble binder including a (meth)acrylamide-based monomer polymerization unit described later are bound better closely chemically or by a secondary bond such as a hydrogen bond, thereby further improving a low-voltage defective rate of a battery with a thin separator.

In an embodiment, the inorganic particle layer may include a binder and inorganic particles, and may be a porous inorganic particle layer in which the inorganic particles are connected or fixed by the binder to form pores. In an embodiment, the inorganic particle layer is provided on at least one surface of the porous substrate, and may occupy an area fraction of 60% or more, 70% or more, 80% or more, or 90% or more based on the entire surface of the porous substrate.

In an embodiment, the inorganic particle layer may be coated on one surface or both surfaces of the porous substrate, and when both surfaces of the porous substrate are coated with the inorganic particle layer, the thicknesses of the inorganic particle layers coated on one surface and the other surface may be the same as or different from each other. Though not particularly limited, in an embodiment, the inorganic particle layer coated on one surface may have a thickness of more than 0 μm, 0.3 μm or more, 0.5 μm or more and 3 μm or less, 2.5 μm or less, 2 μm or less, or between the numerical values. In an embodiment, the inorganic particle layer may have the thickness of more than 0 μm and 3 μm or less. In an embodiment, the inorganic particle layer may more than 0 μm and 2.5 μm or less. In an embodiment, the inorganic particle layer may more than 0 μm and 2 μm or less.

In an embodiment, the inorganic particles are not limited as long as they are inorganic particles used in the art. A non-limiting example of the inorganic particles may include one or two or more of metal hydroxides, metal oxides, metal nitrides, and metal carbides, or one or two or more of SiO₂, SiC, MgO, Y₂O₃, Al₂O₃, CeO₂, CaO, ZnO, SrTiO₃, ZrO₂, TiO₂, and AlO(OH). In view of battery stability and the like, the inorganic particles may be for example metal hydroxide particles such as boehmite.

Though the metal hydroxide is not particularly limited, a non-limiting example thereof may include one or two or more of boehmite, aluminum hydroxide, and magnesium hydroxide. In an embodiment, when the boehmite is used, for example, it may have a specific surface area (BET) of 10 m²/g or more or 15 m²/g or more, but is not limited thereto.

As a example, the inorganic particles may be boehmite, and the boehmite may have a surface area (BET) of 10 m²/g or more, or 15 m²/g or more, but is not limited thereto.

In an embodiment, inorganic particles having a specific particle size distribution and a water-soluble binder including a (meth)acrylamide-based monomer polymerization unit described later are applied together to an inorganic particle layer, thereby further decreasing a low-voltage defective rate of a battery with a thin separator, but is not limited thereto. According to the embodiment, in the particle size distribution of the inorganic particles, a (D80−D20)/D50 value may be 0.01 or more, 0.03 or more, 0.05 or more, 0.1 or more, 0.2 or more and 2.0 or less, 1.8 or less, 1.5 or less, 1.3 or less, 1.2 or less, or a value between the numerical values. As a non-limiting example, the (D80−D20)/D50 value may be 0.01 to 2.0. In an embodiment, the (D80−D20)/D50 value may be, 0.01 to 1.8. In an embodiment, the (D80−D20)/D50 value may be 0.01 to 1.5. In an embodiment, when the inorganic particles satisfy the particle size distribution in the above range, the low-voltage defective rate of a battery may be further decreased.

Though it is not particularly limited as long as the particle size distribution is satisfied, a non-limiting example of the D50 value of the inorganic particles may be 1.0 μm or less or 0.7 μm or less.

In an embodiment, the inorganic particle layer may have a packing density of 1.45 g/(m²·μm) or more, 1.5 g/(m²·μm) or more and 2.5 g/(m²·μm) or less, 2.3 g/(m²·μm) or less, 2.0 g/(m²·μm) or less, or a value between the numerical values. For example, 1.45 to 2.5 g/(m²·μm), 1.5 to 2.3 g/(m²·μm), or 1.5 to 2.0 g/(m²·μm), but is not limited thereto.

Next, an embodiment of the binder which connects the inorganic particles to form an inorganic particle layer having pores formed therein will be described. According to an embodiment of the present disclosure, the binder may be a water-soluble binder including a (meth)acrylamide-based monomer polymerization unit.

In an embodiment, the water-soluble binder including may be a copolymer including a unit derived from a (a) (meth)acrylamide-based monomer, a (b) hydroxyl group-containing (meth)acrylate-based monomer, and a (c) polyfunctional (meth)acrylamide-based monomer. In an embodiment, the copolymer may be a block copolymer or a random copolymer, but is not particularly limited thereto.

According to an embodiment, when the water-soluble binder is used, a separator which may achieve an effect of decreasing a high-temperature shrinkage rate of the manufactured separator as compared with a conventional water dispersion-based binder, solve a problem that inorganic particles in the inorganic particle layer fall and are separated, and show decreased interface resistance characteristics may be provided. In addition, an electrochemical device manufactured using the separator has decreased electrical resistance and may have improved performance in terms of capacity and output.

In an embodiment, the (a) (meth)acrylamide-based monomer polymerization unit may include a structure of the following Chemical Formula 1:

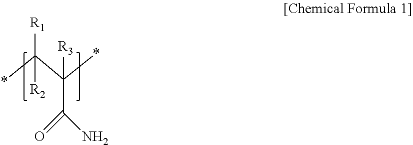

wherein R₁ to R₃ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group.

In an embodiment, the (b) hydroxyl group-containing (meth)acrylate-based monomer polymerization unit may include a structure of the following Chemical Formula 2:

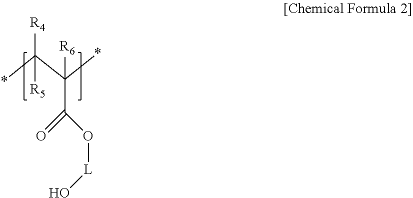

wherein R₄ to R₆ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group, and L is a substituted or unsubstituted, linear or branched C1 to C6 alkylene group.

In an embodiment, the (c) polyfunctional (meth)acrylamide-based monomer polymerization unit may include a structure of the following Chemical Formula 3:

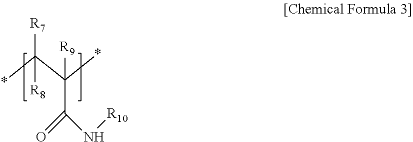

wherein R₇ to R₉ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group, and R₁₀ is a C1 to C10 linear or branched hydrocarbon group including one or more of a hydroxyl group, a carboxyl group, an amine group, an amide group, an ether group, a ketone group, an ester group, and an aldehyde group.

In an embodiment, the copolymer including the (a) (meth)acrylamide-based monomer polymerization unit, the (b) hydroxyl group-containing (meth)acrylate-based monomer polymerization unit, and the (c) polyfunctional (meth)acrylamide-based monomer polymerization unit may include a structure of the following Chemical Formula 4:

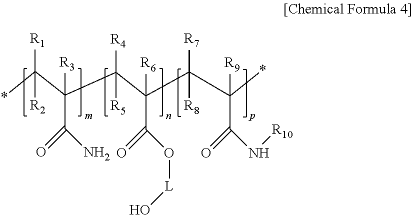

wherein R₁ to R₉ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group, R₁₀ is a C1 to C10 linear or branched hydrocarbon group including one or more of a hydroxyl group, a carboxyl group, an amine group, an amide group, an ether group, a ketone group, an ester group, and an aldehyde group, L is a C1 to C6 substituted or unsubstituted, linear or branched alkylene group, m is 65 to 96, n is 4 to 34, and p is 0.001 to 1. In Chemical Formula 4, m, n, and p refer to contents (mol %) of the (a) (meth)acrylamide-based monomer polymerization unit, the (b) hydroxyl group-containing (meth)acrylate-based monomer polymerization unit, and the (c) polyfunctional (meth)acrylamide-based monomer polymerization unit in the copolymer of Chemical Formula 4 with respect to the total moles.

The binder satisfying the range of the contents of m, n, and p may further decrease the low-voltage defective rate of a battery, may further improve adhesive strength, may further decrease the heat shrinkage rate at a high temperature, and may provide a separator having lower resistance. In an embodiment, the value of m+n+p which is the sum of the contents of m, n, and p may be 100.

In an embodiment, a content m of the (a) (meth)acrylamide-based monomer

polymerization unit in the copolymer may be 65 or more, 67 or more, 68 or more, 70.5 or more and 96 or less, 94 or less, 93 or less, 91.5 or less, or a value between the numerical values. In an embodiment, m may be 65 to 96, 67 to 94, 68 to 93, or 70.5 to 91.5.

In an embodiment, a content n of the (b) hydroxyl group-containing (meth)acrylate-based monomer polymerization unit in the copolymer may be 4 or more, 5 or more, 6 or more, 8 or more and 34 or less, 33 or less, 32 or less, 31 or less, 29 or less, or a value between the numerical values. In an embodiment, n may be 4 to 34, 5 to 33, 6 to 32, 8 to 31, or 8 to 29.

In an embodiment, a content p of the (c) polyfunctional (meth)acrylamide-based monomer polymerization unit in the copolymer may be 0.001 or more, 0.002 or more, or 0.003 or more, and in order to further decrease the heat shrinkage rate at a high temperature, may be 0.01 or more or 0.02 or more and 1 or less, 0.9 or less, 0.5 or less, or a value between the numerical values. In an embodiment, p may be 0.001 to 1, 0.002 to 0.9, or 0.003 to 0.5, and in order to further decrease the heat shrinkage rate at a high temperature, may be 0.01 to 1 or 0.02 to 0.9.

In an embodiment, the binder may have a weight average molecular weight of 100,000 g/mol or more, 200,000 g/mol or more and 2,000,000 g/mol or less, 1,000,000 g/mol or less, 500,000 g/mol or less, or a value between the numerical values. In an embodiment, the binder may have a weight average molecular weight of 100,000 to 2,000,000 g/mol, 200,000 to 1,000,000 g/mol, or 200,000 to 500,000 g/mol. According to an embodiment, when the weight average molecular weight of the binder satisfies the above range, adhesion may be further improved. The weight average molecular weight is an average molecular weight in terms of polyethylene glycol measured using gel permeation chromatography.

A method of preparing the binder is not particularly limited as long as the binder according to the embodiment described above may be provided, but in an embodiment, the binder may be provided by various polymerization methods known in the art such as emulsion polymerization, suspension polymerization, mass polymerization, solution polymerization, bulk polymerization, or a combination thereof.

An embodiment may provide a separator having excellent heat resistance while also significantly decreasing the low-voltage defective rate of a battery. According to an embodiment, a separator having a heat shrinkage rate in MD and TD of 2% or less, 1.5% or less, or 1.3% or less, and in a specific embodiment, 1.0% or less, 0.8% or less, or 0.7% or less may be provided, the heat shrinkage rate being measured after allowing the separator to stand at 150° C. for 60 minutes.

In an embodiment, a new separator satisfying all of the physical properties of the embodiments described above may be provided.

Next, an embodiment of a method of manufacturing the separator will be described.

According to an embodiment, a method of manufacturing a separator including: (s1) preparing a slurry including a water-soluble binder including a (meth)acrylamide-based monomer polymerization unit and inorganic particles; and (s2) forming an inorganic particle layer on at least one surface of a hydrophilically surface-treated porous substrate with the prepared slurry may be provided.

Hereinafter, each process of the method of manufacturing a separator according to the embodiment will be described. Since the descriptions of the porous substrate, the inorganic particle layer, the inorganic particles, and the binder are as described above, they will be omitted for convenience.

In an embodiment, the water-soluble binder may be a copolymer of a (a) (meth)acrylamide-based monomer, a (b) hydroxyl group-containing (meth)acrylate-based monomer, and a (c) polyfunctional (meth)acrylamide-based monomer.

The (a) (meth)acrylamide-based monomer is not particularly limited as long as a polymerization unit including the structure of Chemical Formula 1 described above may be provided, but in an embodiment, the (a) (meth)acrylamide-based monomer may include one or more of acrylamide and methacrylamide, and for example, may include acrylamide.

The (b) hydroxyl group-containing (meth)acrylate-based monomer is not particularly limited as long as the polymerization unit of Chemical Formula 2 described above may be provided, but in an embodiment, the (b) hydroxyl group-containing (meth)acrylate-based monomer may include one or more of hydroxyalkyl (meth)acrylates including 2-hydroxymethyl acrylate, 2-hydroxyethyl acrylate, 2-hydroxyethyl methacrylate, 2-hydroxypropyl (meth)acrylate, and 4-hydroxybutyl (meth)acrylate, and for example, may include 2-hydroxyethyl acrylate.

The (c) polyfunctional (meth)acrylamide-based monomer is not particularly limited as long as the polymerization unit including the structure of Chemical Formula 3 described above may be provided, but in an embodiment, the (c) polyfunctional (meth)acrylamide-based monomer may include one or more of N-[tris(hydroxymethyl)methyl]methacrylamide, N-[tris(hydroxymethyl)methyl] acrylamide, N-(4-hydroxy-3,3-bis(hydroxymethyl)butylmethacrylamide, N-(4-hydroxy-3,3-bis(hydroxymethyl)butyl acrylamide, N,N′-methylenebisacrylamide, N,N′-hexamethylenebisacrylamide, and N,N′-(1,2-dihydaroxyethylene)bisacrylamide, and for example, N,N′-methylenebisacrylamide.

In a specific embodiment, the water-soluble binder may be obtained by copolymerizing a mixture including a monomer component including the (a) (meth)acrylamide-based monomer, the (b) hydroxyl group-containing (meth)acrylate-based monomer, and the (c) polyfunctional (meth)acrylamide-based monomer; and a polymerization initiator.

In an embodiment, the type of polymerization initiator is not particularly limited as long as the copolymer may be obtained, but in an embodiment, the polymerization initiator may be a persulfuric acid-based polymerization initiator such as potassium persulfate, sodium persulfate, and ammonium persulfate.

According to an embodiment, the water-soluble binder obtained by copolymerizing the mixture may have a weight average molecular weight of 100,000 g/mol or more, 200,000 g/mol or more, 250,000 g/mol or more and 2,000,000 g/mol or less, or a value between the numerical values. In an embodiment, the binder may have a weight average molecular weight of 100,000 to 2,000,000 g/mol, 200,000 to 2,000,000 g/mol, or 250,000 to 2,000,000 g/mol. According to an embodiment, when the weight average molecular weight of the binder satisfies the above range, adhesion may be further improved. The weight average molecular weight is an average molecular weight in terms of polyethylene glycol measured using gel permeation chromatography.

Without being limited, in an embodiment, the water-soluble binder may be provided by various polymerization methods known in the art such as emulsion polymerization, suspension polymerization, mass polymerization, solution polymerization, bulk polymerization, or a combination thereof.

According to an embodiment, the water-soluble binder may be obtained by adding a monomer component including the (a) (meth)acrylamide-based monomer, the (b) hydroxyl group-containing (meth)acrylate-based monomer, and the (c) polyfunctional (meth)acrylamide-based monomer to distilled water, heating to 50 to 90° C. or 60 to 80° C., and then adding a polymerization initiator to perform polymerization.

In an embodiment, after the polymerization reaction is completed, the temperature is lowered to room temperature (20±5° C.) and a basic solution and the like are added to prepare a water-soluble binder aqueous solution adjusted to a neutral state. In an embodiment, the water-soluble binder aqueous solution may have a viscosity of 3000 cps or less, 2500 cps or less, or 2000 cps or less. In an embodiment, 1500 cps or less, but is not limited thereto. When the binder is mixed with inorganic particles later in the viscosity range to prepare a slurry, the viscosity of the slurry may be further lowered and applicability may be further improved.

As a method of preparing the slurry, all common methods known in the art may be applied without limitation, and though it is not particularly limited, according to a non-limiting example, the slurry may be prepared by performing stirring at 0 to 60° C. for 1 hour to 5 days to disperse inorganic particles having the particle size distribution described above, and agglomerated inorganic particles may be dispersed using a ball mill.

According to an embodiment, an inorganic particle layer may be provided on at least one surface of a hydrophilically surface-treated porous substrate by the process (s2). As a method of applying the slurry, any common method known in the art may be applied without limitation, and according to a non-limiting example, roll coating, spin coating, dip coating, bar coating, die coating, slit coating, inkjet printing, and a combination of these methods may be applied. Drying for forming the inorganic particle layer is not particularly limited, but may be performed at 100° C. or lower or 30 to 60° C.

Unlike a common process of applying a slurry on a porous substrate and then transferring it to a drier immediately within 1 minute to perform drying, according to an embodiment of the present disclosure, in the process (s2), as a means for further decreasing the low-voltage defective rate of a battery, a process of allowing the substrate to stand at room temperature for 5 minutes or more may be included after applying the slurry. This is a process of allowing it to stand 5 minutes or more, and may impart a time for rearranging the inorganic particles and the water-soluble binder in the slurry and further decrease the low-voltage defective rate of a battery therefrom. It is appropriate that the standing time is imparted over a certain period of time, but when the time is too long, process efficiency may be impaired, which is thus not preferred. Considering the fact, the standing time may be 5 minutes or more, 8 minutes or more, 10 minutes or more, 30 minutes or less, 25 minutes or less, 20 minutes or less, or a value between the numerical values. A specific non-limiting example of the standing time may be 5 to 30 minutes or 5 to 25 minutes.

In an embodiment, the hydrophilic surface treatment of the porous substrate may be performed by including one or more of a corona discharge treatment and a plasma discharge treatment, and a polar functional group such as a carboxyl group, an aldehyde group, and a hydroxyl group may be introduced by the hydrophilic surface treatment. When the polar functional group is included on the surface of the porous substrate, the water-soluble binder fixing the inorganic particle layer and the polar functional group on the porous substrate interact chemically or by a hydrogen bond or the like and are bound more closely, thereby further decreasing the low-voltage defective rate of a battery with a thin separator.

In an embodiment, after performing drying for forming the inorganic particle layer, a process of aging the porous substrate having the inorganic particle layer formed thereon may be further included. In an embodiment, the aging may be performed at 50 to 150° C. In an embodiment, the aging may be performed at 65 to 120° C. In an embodiment, an aging time may be 2 hours to 24 hours. In an embodiment, an aging time may be 10 to 20 hours. In an embodiment, the aging may be performed in a temperature range of 70 to 120° C. for 10 to 15 hours. The aging is preferred since adhesive strength between the porous substrate and the inorganic particle layer may be increased and heat resistance at a high temperature may be further improved, by the aging.

According to an embodiment, an electrochemical device including the separator according to an embodiment of the embodiments described above may be provided, and the electrochemical device may be any known energy storage device, and though it is not particularly limited, as a non-limiting example, may be a lithium secondary battery. Since the lithium secondary battery is well known and its configuration is also known, it will not be described in detail in the present disclosure.

The lithium secondary battery according to an embodiment may include the separator described above between a positive electrode and a negative electrode. Herein, the positive electrode and the negative electrode may be used without limitation as long as they are commonly used in the lithium secondary battery.

Hereinafter, the present disclosure will be described in more detail, based on the examples and the comparative examples. However, the following examples and the comparative examples are only an example for describing the present disclosure in more detail, and do not limit the present disclosure in any way.

First, the measurement of physical properties and the evaluation method of the separator will be described.

### Weight Average Molecular Weight

The weight average molecular weight was measured using GPC (Tosoh, EcoSEC HLC-8320 GPC Reflective Index detector). Tskgel guard PWx, two TSKgel GMPWxls, and TSKgel G2500PWxl (7.8×300 mm) were used as a GPC column, a 0.1 M NaNO₃ aqueous solution was used as a solvent, polyethylene glycol was used as a standard, and analysis was performed at 40° C. at a flow rate of 1 ml/min.

### Average Thickness of Separator (t, t₁)

The overall average thickness t (μm) of a separator was determined by the following method. The separators were overlapped in 10 layers, each thickness was measured at 5 random points in TD by a thickness meter available from Mitutoyo, the values were divided by 5 to derive an average thickness of the 10-layer separator, and were divided by 10 again to derive an overall average thickness of a single separator.

The average thickness t₁ (μm) of a porous substrate was determined by the following method. Only porous substrates having no inorganic particle layer provided on at least one surface were overlapped in 10 layers, each thickness was measured at 5 random points in TD with a thickness meter available from Mitutoyo, the values were divided by 5 to derive an average thickness of the 10-layer porous substrate, and were divided by 10 again to derive the average thickness t₁ of the porous substrate. In the case in which the average thickness t₁ of the porous substrate having the inorganic particle layer provided on at least one surface was determined, the inorganic particle layer was released using all methods known in the art without limitation and was sufficiently dried, and the average thickness t₁ of the porous substrate from which the inorganic particle layer had been released was determined.

The thickness of the inorganic particle layer may be the average thickness of the inorganic particle layer, which may be measured as follows. First the overall average thickness of the separator having the inorganic particle layer on the porous substrate is measured (e.g. in the same manner as the measurement of the thickness of the porous substrate). Then the inorganic particle layer is released using any method known in the art without limitation and is sufficiently dried, and the average thickness of the porous substrate from which the inorganic particle layer has been released is determined. Then the average thickness of the porous substrate is subtracted from the overall average thickness of the separator to calculate the thickness (μm) of the inorganic particle layer.

### Packing Density of Inorganic Particle Layer

The packing density of an inorganic particle layer was measured by the following method.

According to the method described above, the average thickness t₁ of the porous substrate and the overall average thickness t of the separator having the inorganic particle layer provided on the porous substrate were measured, respectively, and the average thickness t₁ of the porous substrate was subtracted from the overall average thickness t of the separator to calculate the thickness (T, μm) of the inorganic particle layer. The separator having the inorganic particle layer provided on the porous substrate was cut into an area (S, m²) of 10 mm×10 mm (0.01 m²) to measure the weight, and the weight of the porous substrate alone was subtracted to calculate the weight (W, g) of the inorganic particle layer alone. The packing density of the inorganic particle layer was calculated by W/(T*S) (g/(m²·μm)).

### Viscosity Measurement

The viscosity was measured under the ASTM D 2196 Standard Test Methods for Rheological Properties of Non-Newtonian Materials by Rotational Viscometer,² and specifically by setting rpm to a torque of 60-70% by a Brookfield viscometer (model RVDV2), spindle of CPA-52Z at 25° C. ² See ASTM website at https://www.astm.org/d2196-20.html.

### BDV/t

The dielectric breakdown voltage (BDV) was measured in accordance with ASTM D 3755 Standard Test Method for Dielectric Breakdown Voltage and Dielectric Strength of Solid Electrical Insulating Materials Under Direct-Voltage Stress,³ and was evaluated as a voltage (kV) when a leakage current value was 5 mA, which was measured under the conditions of placing the separator between electrodes of a withstand voltage tester (Croma, model 19052) under a dry room (dew point temperature: −60° C.) and then raising an applied voltage to 5 kV/10 sec. ³ See ASTM website at https://www.astm.org/d3755-20.html.

The overall average thickness t (μm) of the separator was obtained by overlapping the separators in 10 layers, measuring each thickness at 5 random points in TD by a thickness meter available from Mitutoyo, dividing the values by 5 to derive an average thickness of the 10-layer separator, and dividing the values by 10 again to derive the overall average thickness of a single separator.

Thereafter, for comparison of the secured dielectric breakdown voltage versus thickness, a BDV/t value which is a ratio of the dielectric breakdown voltage BDV measured above to the overall average thickness t of the separator was determined.

### Low-Voltage Defective Rate

After an initial resistance of the manufactured battery was measured, a voltage thereof was measured in a 50% state of charge, a voltage drop was measured after 3 weeks, and when a voltage drop of 20 mV or more occurred, it was evaluated as a low-voltage defect.

The low-voltage defect of each of 20 manufactured secondary batteries was determined by the above method, and then the low-voltage defective rate of the battery was evaluated by the following grade depending on the frequency of low-voltage defect occurrences:
A: low frequency of low-voltage defect occurrences
B: high frequency of low-voltage defect occurrences
C: very high frequency of low-voltage defect occurrences

### Heat Shrinkage Rate

The heat shrinkage rate of the separator was measured based on ASTM D 1204, by the following method. Grid points were marked at 2 cm intervals on a square having sides of 10 cm on a separator. One side of the square was the transverse direction (TD) and the other side of the square was the machine direction (MD). A specimen was placed in the center, 5 sheets of paper were placed each on the top and the bottom of the specimen, and the four sides of the paper were wrapped with tape. The specimen wrapped in paper was allowed to stand in a hot air drying oven at 150° C. for 60 minutes. Thereafter, the specimen was taken out and the separator was observed with a camera, thereby calculating the shrinkage rate in the length direction of the following Equation 1 and the shrinkage rate in the width direction of the following Equation 2:

Shrinkage rate in the length direction (%)=(length in the length direction before heating−length in the length direction after heating)×100/ length in the length direction before heating Equation 1

Shrinkage rate in the width direction (%)=(length in the width direction before heating−length in the width direction after heating)×100/ length in the width direction before heating Equation 2

### Adhesion

A separator was cut into a size of 50 mm wide×50 mm long and placed so that the inorganic particle layer was on top. A piece of black drawing paper (20 mm wide×150 mm long×0.25 mm thick) having a coefficient of dynamic fraction of 0.15 was placed thereon, a pressing device was used to apply a certain pressure (200 g/cm²), the black drawing paper was forcibly pulled to the side, and a degree of inorganic substance adhered on the surface was confirmed and determined as A/B/C/D/F depending on the adhesion degree, referring to the following grade:
A: no adhesion
B: inorganic substance adhered in a small amount
In C-F, the binder and the inorganic substance were adhered together and the degree was severe toward F.

### EXAMPLES

### Example 1

### Preparation of Binder

The inside of a 1.0 L flask was replaced with nitrogen, a monomer component of (a) 932 mmol of acrylamide, (b) 89 mmol of 2-hydroxyethylmethacrylate, and (c) 0.058 mmol of N,N′-methylenebisacrylamide and 700 g of distilled water were added to the flask, and then the flask was heated to 75° C. Thereafter, 0.789 mmol of ammonium persulfate as a polymerization initiator was further added to the flask, the flask was closed, and a polymerization reaction of the mixture proceeded. After proceeding with the polymerization reaction for 12 hours, the closed flask was opened to the air to lower the temperature to room temperature, a 1 M sodium hydroxide solution was added to adjust the pH to 7, thereby preparing a binder aqueous solution. The physical properties of the binder and the binder aqueous solution are shown in the following Table 1.

### Preparation of Slurry

96.5 wt % of boehmite (γ-AlO(OH), boehmite)(D20: 0.17 μm, D50: 0.28 μm, D80: 0.55 μm, (D80−D20)/D50: 1.36) as the inorganic particles and 3.5 wt % of the binder prepared above, based on the total weight of the solid content, were added to water, and stirring was performed to prepare a slurry having a solid content concentration of 28 wt %.

### Pretreatment of Porous Substrate

Both surfaces of a polyethylene porous film (porosity: 40%, Gurley permeability: 159 sec/100 cc, tensile strength MD 2,430 kgf/cm², TD 1,877 kgf/cm²) having an average thickness of 9 μm as a porous substrate film were corona discharge-treated (power density: 2 W/mm) to introduce a surface polar group, and the corona surface treatment was performed at a speed of 3 to 20 mpm (meter per minute).

### Manufacture of Separator

The slurry was applied on both surfaces of the pretreated porous substrate, and was allowed to stand for 5 minutes. Thereafter, the substrate was dried to form an inorganic particle layer having an average thickness of 2 μm, respectively (t=13 μm) on both surfaces. The porous substrate having the inorganic particle layer provided thereon was aged at 100° C. for 12 hours to manufacture a separator. t₁/t was 0.69. The physical properties of the separator are shown in the following Table 3.

### Manufacture of Secondary Battery:

94 wt % of LiCoO₂ as a positive active material, 2.5 wt % of polyvinylidene fluoride as a fusing agent, and 3.5 wt % of carbon black as a conductive agent were added to N-methyl-2-pyrrolidone (NMP) as a solvent, and stirring was performed to prepare a uniform positive electrode slurry. The slurry prepared above was coated on an aluminum foil having a thickness of 30 μm, dried, and pressed to manufacture a positive electrode having a total thickness of 150 μm. 95 wt % of artificial graphite as a negative electrode active material, 3 wt % of acryl-based latex having Tg of −52° C. as a fusing agent, and 2 wt % of carboxymethyl cellulose (CMC) as a thickener were added to water as a solvent, and stirring was performed to prepare a uniform negative electrode slurry. The slurry prepared above was coated on a copper foil having a thickness of 20 μm, dried, and pressed to manufacture a negative electrode having a total thickness of 150 μm. The positive electrode, the negative electrode, and the separator manufactured above were assembled into a pouch type battery so that the separator was stacked between the positive electrode and the negative electrode, and the assembled battery was heat-fused at 80° C. and 1 MPa with a heat press machine so that the positive electrode, the negative electrode, and the separator were fused to each other. Thereafter, an electrolyte solution in which 1 M lithium hexafluorophosphate (LiPF₆) was dissolved was injected into a solution including ethylene carbonate (EC), ethylmethyl carbonate (EMC), and dimethyl carbonate (DMC) at a volume ratio of 30:50:20, and the solution was sealed to manufacture a secondary battery having a capacity of 2 Ah.

### Examples 2 to 4

Binders were prepared in the same manner as in Example 1, except that the binders were prepared with the compositions of the following Table 1, and slurries were prepared in the same manner as in Example 1, except that boehmite having the particle size distribution of the following Table 2 was used, and were manufactured into separators and secondary batteries. The physical properties of the separators are shown in the following Table 3.

### Comparative Examples 1 to 3

Binders, slurries, separators, and secondary batteries were manufactured in the same manner as in Example 1, except that the binders were prepared with the compositions of the following Table 1. The physical properties of the separators are shown in the following Table 3.

### Comparative Example 4

A slurry, a separator, and a secondary battery were manufactured in the same manner as in Example 1, except that boehmite particles having the particle size distribution of the following Table 2 were used. The physical properties of the separators are shown in the following Table 3.

### Comparative Example 5

A binder, a slurry, a separator, and a secondary battery were manufactured in the same manner as in Example 1, except that a water dispersion-based binder having a latex content of 20 wt % as a commercial acryl-based water dispersion-type binder, not the water-soluble binder, was used. The physical properties of the separators are shown in the following Table 3.

TABLE 1

| | | | | Polymerization | Binder | Weight |
|---|---|---|---|---|---|---|
| | | | | initiator | aqueous | average |
| | Monomer component | | | Ammonium | solution | molecular |
| | AM | 2-HEMA | MBAA | persulfate | viscosity | weight |
| | (mmol) | (mmol) | (mmol) | (mmol) | (cps) | (g/mol) |
| Example 1 | 932 | 89 | 0.058 | 0.789 | 956 | 250,000 |
| Example 2 | 932 | 89 | 0.324 | 0.789 | 1132 | 270,000 |
| Example 3 | 784 | 209 | 0.058 | 0.789 | 1025 | 250,000 |
| Example 4 | 706 | 316 | 0.058 | 0.789 | 1020 | 270,000 |
| Comparative | 1055 | 0 | 0 | 0.789 | 1427 | 280,000 |
| Example 1 | | | | | | |
| Comparative | 878 | 204 | 0 | 0.789 | 1137 | 300,000 |
| Example 2 | | | | | | |
| Comparative | 1055 | 0 | 0.195 | 0.789 | 1334 | 300,000 |
| Example 3 | | | | | | |
| Comparative | 932 | 89 | 0.058 | 0.789 | 956 | 250,000 |
| Example 4 | | | | | | |
| Comparative | — | — | — | — | 674 | — |
| Example 5 | | | | | | |

In Table 1, AM is Acrylamide, 2-HEMA is 2-hydroxyethyl methacrylate, and MBAA is N,N′-methylenebisacrylamide.

TABLE 2

Inorganic particle size distribution

| | D20 | D50 | D80 | (D80 − D20)/D50 |
|---|---|---|---|---|
| Example 1 | 0.17 | 0.28 | 0.55 | 1.36 |
| Example 2 | 0.35 | 0.7 | 1.53 | 1.69 |
| Example 3 | 0.35 | 0.55 | 1.01 | 1.20 |
| Example 4 | 0.24 | 0.43 | 0.82 | 1.35 |
| Comparative | 0.17 | 0.28 | 0.55 | 1.36 |
| Example 1 | | | | |
| Comparative | 0.17 | 0.28 | 0.55 | 1.36 |
| Example 2 | | | | |
| Comparative | 0.17 | 0.28 | 0.55 | 1.36 |
| Example 3 | | | | |
| Comparative | 0.35 | 0.52 | 1.86 | 2.90 |
| Example 4 | | | | |
| Comparative | 0.73 | 1.49 | 2.32 | 1.07 |
| Example 5 | | | | |

### Evaluation Example

### Physical Properties of Separator

The results of evaluating the physical properties of the separators of the examples and the comparative examples of the present disclosure are summarized and shown in the following Table 3.

TABLE 3

| | Inorganic | | | | | | |
|---|---|---|---|---|---|---|---|
| | particle layer | Separator | | | | | Strawboard |
| | packing density | thickness | BDV/t | Low-voltage | Heat shrinkage rate (%) | | adhesive |
| | (g/(m² · μm)) | (t) (μm) | (kV/μm) | defective rate | MD | TD | strength |
| Example 1 | 1.58 | 12.7 | 0.168 | A | 0.4 | 0.7 | A |
| Example 2 | 1.54 | 13.2 | 0.157 | A | 0.2 | 0.1 | A |
| Example 3 | 1.62 | 13 | 0.162 | A | 0.4 | 0.5 | A |
| Example 4 | 1.57 | 13 | 0.158 | A | 0.3 | 0.5 | A |
| Comparative | 1.36 | 13 | 0.142 | B | 6.2 | 4.5 | B |
| Example 1 | | | | | | | |
| Comparative | 1.41 | 12.9 | 0.149 | B | 3 | 2.5 | B |
| Example 2 | | | | | | | |
| Comparative | 1.39 | 13 | 0.135 | B | 7.5 | 4.5 | A |
| Example 3 | | | | | | | |
| Comparative | 1.02 | 13 | 0.122 | B | >50 | >50 | C |
| Example 4 | | | | | | | |
| Comparative | 0.99 | 13 | 0.131 | C | 63.8 | 47.2 | A |
| Example 5 | | | | | | | |

Examples 1 to 4 which are embodiments of the present disclosure had the BDV/t value satisfying 0.15 or more as compared with Comparative Examples 1 to 5, and as a result, it was confirmed that the low-voltage defective rate of the battery was significantly decreased even at a small thickness, heat resistance was excellent with the heat shrinkage rate in MD and TD of 2% or less as measured after allowing the separator to stand at 150° C. for 60 minutes, and adhesion was significantly improved with the strawboard adhesive strength of A.

In particular, Example 2 in which the content of MBAA as the polyfunctional (meth)acrylamide-based monomer was 0.01 mol % or more showed best heat resistance with the heat shrinkage rate in MD and TD of 0.2% or less among the examples.

However, Comparative Examples 1 to 3 had the BDV/t value of 0.15 or less, and as a result, had a high low-voltage defective rate of the battery and poor heat resistance with the heat shrinkage rate in MD and TD of 2% or more.

Comparative Example 4 had the BDV/t value of 0.15 or less, and as a result, had a high low-voltage defective rate of the battery and poor heat resistance and adhesion as compared with the examples.

Comparative Example 5 used a commercial acryl-based water dispersion-type binder and had the BDV/t value of 0.15 or less, and as a result, had very high low-voltage defect of the battery and very poor heat resistance.

According to the present disclosure, a separator which includes the water-soluble binder of the present embodiment as the binder of an inorganic particle layer and has a value of the following Formula (1) satisfying 0.15 or more, 0.153 or more, or 0.155 or more may significantly decrease the low-voltage defective rate of a battery having a decreased voltage at the voltage of a battery to be desired even with a small thickness and also may secure excellent heat resistance and adhesion:

BDV/t (1)

wherein BDV is measured in accordance with ASTM D 3755, and is a voltage (kV) when a leakage current value is 5 mA, which was measured under conditions of placing the separator between electrodes of a withstand voltage tester and then raising an applied voltage to 5 kV/10 sec, and t is an overall average thickness (μm) of the separator.

In an embodiment, a heat shrinkage rate in MD and TD measured after the separator is allowed to stand at 150° C. for 60 minutes may be 2% or less, 1.5% or less, or 1.3% or less, and in a specific embodiment, 1.0% or less, 0.8% or less, or 0.7% or less.

In a specific embodiment, a packing density of the inorganic particle layer may be further increased and the low-voltage defective rate of a battery may be further decreased even with the separator having the same thickness, by applying the water-soluble binder and inorganic particles having a specific particle size distribution together to an inorganic particle layer.

In an embodiment, the packing density of the inorganic particle layer may be 1.45 g/(m²·μm) or more or 1.5 g/(m²·μm) or more and 2.5 g/(m²·μm) or less, 2.3 g/(m²·μm) or less, or 2.0 g/(m²·μm) or less, or a value between the numerical values.

In an embodiment, in the particle size distribution of the inorganic particles, when a (D80−D20)/D50 value may be 0.01 to 2.0, the inorganic particles bind to the water-soluble binder, so that the packing density is further increased and the low-voltage defective rate of a battery may be further decreased.

In an embodiment, when a hydrophilic surface treatment including one or more of a corona discharge treatment and a plasma discharge treatment is performed on the porous substrate, the packing density of the inorganic particle layer may be further increased, thereby further decreasing the low-voltage defective rate of a battery with a thin separator. In an embodiment, a polar functional group is provided on the surface of the porous substrate by the corona discharge treatment or the plasma discharge treatment, and the provided polar functional group is bound to the water-soluble binder which fixes the inorganic particle layer chemically or closely by a secondary binding force such as a hydrogen bond, thereby further decreasing the low-voltage defective rate of a battery.

In addition, in a specific embodiment, after forming the inorganic particle layer, an aging process is performed to further increase adhesion between the porous substrate and the inorganic particle layer and further improving heat resistance.

In a more specific embodiment, a new separator satisfying all of the physical properties may be provided.

The disclosed technology can be implemented in various electrochemical devices such as rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

What is claimed is:

1. A separator for a secondary battery, the separator comprising:
a porous substrate; and
an inorganic particle layer including a binder and inorganic particles on at least one surface of the porous substrate,
wherein the binder includes a water-soluble binder material including a unit derived from a (meth)acrylamide-based monomer, and the separator exhibits a value of the following Formula (1) satisfying 0.15 or more:
BDV/t (1)
wherein
‘BDV’ is a voltage in kilovolts (kV) measured in accordance with ASTM D 3755 Standard Test Method for Dielectric Breakdown Voltage and Dielectric Strength of Solid Electrical Insulating Materials Under Direct-Voltage Stress, when a leakage current value is 5 mA, measured under conditions of raising an applied voltage at 5 kV/10 sec after placing the separator between electrodes of a withstand voltage tester (Hipot Tester), and
‘t’ is an overall average thickness in microns (μm) of the separator.

2. The separator of claim 1, wherein in a particle size distribution of the inorganic particles, a (D80−D20)/D50 value is 0.01 to 2.0,
wherein D80 refers to a particle diameter where 80% of the inorganic particles have particle diameters less than D80, D20 refers to a particle diameter where 20% of the inorganic particles have particle diameters less than D20, and D50 refers to a particle diameter where 50% of the inorganic particles have particle diameters less than D50.

3. The separator of claim 1, wherein when an average thickness of the porous substrate is t₁, a t₁/t value is 0.65 or more.

4. The separator of claim 1, wherein the inorganic particle layer has a packing density of 1.45 g/(m²·μm) or more.

5. The separator of claim 1, wherein the porous substrate includes a polar functional group on the surface.

6. The separator of claim 1, wherein a heat shrinkage rate in MD and TD is 2% or less, which was measured after the separator is allowed to stand at 150° C. for 60 minutes.

7. The separator of claim 1, wherein the binder is a copolymer including a unit derived from the (a) (meth)acrylamide-based monomer, (b) a hydroxyl group-containing (meth)acrylate-based monomer, and (c) a polyfunctional (meth)acrylamide-based monomer.

8. The separator of claim 7, wherein the (c) polyfunctional (meth)acrylamide-based monomer in the copolymer includes a structure of the following Chemical Formula 3: 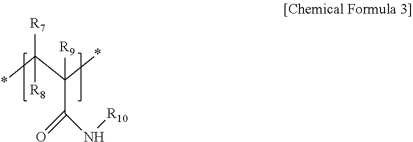
wherein R₇ to R₉ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group, and R₁₀ is a C1 to C10 linear or branched hydrocarbon group including one or more of a hydroxyl group, a carboxyl group, an amine group, an amide group, an ether group, a ketone group, an ester group, and an aldehyde group.

9. The separator of claim 8, wherein the copolymer includes a structure of the following Chemical Formula 4: 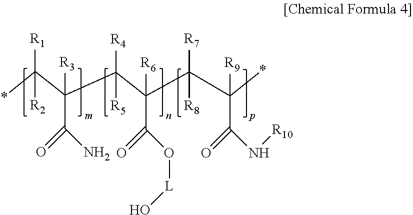
wherein R₁ to R₉ are independently of one another a functional group including one or more of hydrogen; a substituted or unsubstituted, linear or branched C1 to C6 alkyl group; a substituted or unsubstituted, linear or branched C1 to C6 alkoxy group; a substituted or unsubstituted, linear or branched C2 to C6 alkenyl group; and a substituted or unsubstituted, linear or branched C2 to C6 alkynyl group, R₁₀ is a C1 to C10 linear or branched hydrocarbon group including one or more of a hydroxyl group, a carboxyl group, an amine group, an amide group, an ether group, a ketone group, an ester group, and an aldehyde group, L is a C1 to C6 substituted or unsubstituted, linear or branched alkylene group, m is 65 to 96, n is 4 to 34, and p is 0.001 to 1.

10. The separator of claim 9, wherein in Chemical Formula 4, p is 0.01 to 1.

11. The separator of claim 1, wherein the binder has a weight average molecular weight of 100,000 to 2,000,000 g/mol.

12. The separator of claim 1, wherein the inorganic particle layer has a thickness of 3 μm or less.

13. A method of manufacturing a separator, the method comprising:
(s1) preparing a slurry including a water-soluble binder including a unit derived from (meth)acrylamide-based monomer and inorganic particles; and
(s2) using the prepared slurry to form an inorganic particle layer on at least one surface of a hydrophilically surface-treated porous substrate.

14. The method of manufacturing a separator of claim 13, wherein the inorganic particles have a (D80−D20)/D50 value of 0.01 to 2.0,
wherein D80 refers to a particle diameter where 80% of the inorganic particles have particle diameters less than D80, D20 refers to a particle diameter where 20% of the inorganic particles have particle diameters less than D20, and D50 refers to a particle diameter where 50% of the inorganic particles have particle diameters less than D50.

15. The method of manufacturing a separator of claim 13, wherein the water-soluble binder is a copolymer of a (a) (meth)acrylamide-based monomer, a (b) hydroxyl group-containing (meth)acrylate-based monomer, and a (c) polyfunctional (meth)acrylamide-based monomer.

16. The method of manufacturing a separator of claim 13, wherein the process (s2) further includes: applying the prepared slurry on at least one surface of the hydrophilically surface-treated porous substrate, and then allowing it to stand for 5 minutes or more.

17. The method of manufacturing a separator of claim 13, wherein the hydrophilic surface treatment of the porous substrate is performed by including one or more of a corona discharge treatment and a plasma discharge treatment.

18. An electrochemical device comprising the separator of claim 1.
